(19) United States
(12) Patent Application Publication
(10) Pub. No.: US 2026/0162839 A1
(43) Pub. Date: Jun. 11, 2026

(54) SYSTEMS AND METHODS FOR STEAM SEPARATOR ALIGNMENT

(71) Applicant: GE-Hitachi Nuclear Energy Americas LLC, Wilmington, NC (US)

(72) Inventors: Kendall L. Woods, Wilmington, NC (US); Brendan J. Erickson, Fall City, WA (US); Derek M. Woody, Wilmington, NC (US); Ryan J. T. Wright, Windber, PA (US)

(21) Appl. No.: 18/972,664

(22) Filed: Dec. 6, 2024

(51) Int. Cl. G21C 15/16; G21C 21/00

(52) U.S. Cl. CPC G21C 15/16; G21C 21/00

(57) ABSTRACT

Systems supply alignment in steam separator assemblies by transversely extending around the separator tubes and preventing skewing or contact among them without the need for alignment bars or perimeter guide rings to join to the bars. A plate or series of connected shapes can match the shape of the separator tubes to provide alignment without direct contact on aligned tubes. This may limit opportunities for damage, wear, and fretting caused by vibration between rigid structures. Coolant and handling structures can pass through or around the bracing structures, allowing cross-flow vertically through the assembly and accommodating handling structures that can move all the separator tubes and their aligners as a rigid body for installation. Systems can be fabricated as steam separator assemblies entirely outside a reactor or about separator tubes at any location including in situ. Steam separator assemblies may then be installed or removed above a reactor vessel core.

### BACKGROUND

As shown in FIG. 1, a nuclear reactor, such as a Boiling Water Reactor (BWR), includes a reactor vessel 12 housing a nuclear fuel core 36 that generates power through nuclear fission. Reactor vessel 12 may be of a generally cylindrical shape, closed at a lower end by bottom head 28 and at a top end by removable top head 29. A cylindrically-shaped core shroud 34 may surround reactor core 36, which includes several nuclear fuel elements or assemblies. Shroud 34 may be supported at one end by shroud support 38 and may include removable shroud head 39 and separator tube assembly at the other end. One or more control blades 20 or other control elements may extend upwards into core 36, so as to control the fission chain reaction within fuel elements of core 36. Additionally, one or more instrumentation tubes 50 may extend into reactor core 36 from outside vessel 12, such as through bottom head 28, permitting instrumentation, such as neutron monitors and thermocouples, to be inserted into and enclosed within the core 36 from an external position.

Fuel bundles may be aligned and supported by fuel support castings 48 located on a core plate 49 at the base of core 36. Castings 48 may receive individual fuel bundles or groups of bundles and permit coolant flow through the same. Fuel support castings 48 may further permit instrumentation tubes 50, control blades 20, and/or other components to pass into core 36 through or between fuel supports 48. A fluid, such as light or heavy water, is circulated up through core plate 49 and core 36, and in a BWR, is at least partially converted to steam by the heat generated by fission in the fuel elements. The steam is separated and dried in steam separator tube assembly 14 and steam dryer structures 15 and exits vessel 12 through a main steam line 3 near a top of vessel 12. Other fluid coolants and/or moderators may be used in other reactor designs, with or without phase change.

FIG. 2 is a cross sectional schematic detail view of vessel 12 taken at an axial level of steam separator tube assembly 14 at a guide ring 13 forming un upper perimeter of assembly 14. As seen in FIG. 2, several steam separator tubes 41 axially extend into the vessel so that steam exiting the core may flow past any supporting standpipes into separator tubes 41 with varying diameters and/or swirl vanes that remove liquid coolant entrained in the steam. Separator tubes 41 may be horizontally aligned to fill the available space; for example, as shown in FIG. 2, separator tubes 41 may be arrayed in a 60-degree lattice. One or more tie bars 42 may pass along several separator tubes 41 and/or guide ring 13, to which they may be rigidly joined, such as by welding. Tie bars 42 align several separator tubes 41 along a given line, such that each separator tube 41 may be braced by three different tie bars 42 in the related art of FIG. 2. Tie bars 42 thus prevent any one separator tube 41 from tilting or translating out of alignment with others along the tie bar's line. Multiple tie bars 42 may be used at different elevations, ensuring alignment throughout an axial dimension of separator tubes 41. Co-owned “General Electric Systems Technology Manual,” Dec. 14, 2014, Chapter 2.1, describes helpful technological context and are incorporated by reference herein in their entireties.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include planes of rigid braces extending across a population of separator tubes to uniformly secure and align the same. The systems together with the separator tubes form steam separator assemblies installable above a boiling water core, such as in a BWR. The braces may take the forms of plates, rings, collars, sleeves, or other structures that directly and indirectly secure to the separator tubes to limit an amount of direct contact and potential fretting between the structures. Where a planar aligner provides tolerance around or does not otherwise directly contact aligned separator tubes, this may reduce fretting from metal direct contact while still preventing large displacements or skews among the separator tubes.

While the separator tubes pass through the aligners, potentially with some tolerance, other holes and passages can be provided to allow a desired amount of coolant cross flow and accommodate other structures like lifting rods, securing bolts, and related art reactor internals. These openings may be selectively positioned and sized to limit a risk of tools or other equipment from passing through a steam separator assembly, such as the use of multiple holes having dimensions only of a few inches or less. In this way example embodiment alignment systems can be installed through existing or new separator tube populations and secured at specific, desired axial heights relative to the separator tubes without interfering with their separating internal passages and function. Up to an entire population of separator tubes within a reactor can be braced and aligned by example embodiments; alternatively, subsets of separator tubes, such as a pair of separator tubes or five separator tubes, for example, can be present and joined as a single body by a planar alignment structure.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is an illustration of a related art nuclear power vessel and internals.

FIG. 2 is a schematic detail illustrations of a related art steam separator assembly.

FIG. 3 is an illustration of an example embodiment steam separator assembly.

FIG. 4A is an illustration of an example embodiment guide plate useable as an aligner in the assembly of FIG. 3.

FIG. 4B is an illustration of an example embodiment sleeve useable as an aligner in the assembly of FIG. 3.

FIG. 5A is an illustration of an example embodiment gusset useable as an aligner in the assembly of FIGS. 5B and 6.

FIG. 5B is an illustration of an example embodiment steam separator assembly.

FIG. 6 is another illustration of the assembly of FIG. 5B.

FIG. 7A is an illustration of an example embodiment aligner useable in the assembly of FIG. 6.

FIG. 7B is an illustration of a fitting useable in the aligner of FIG. 7A.

FIG. 8A is an illustration of an example embodiment aligner useable in the assembly of FIG. 6.

FIG. 8B is an illustration of a fitting useable in the aligner of FIG. 8A.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion.

In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

Proportions, sizes, and shapes shown in the figures are examples for illustration. While they reflect features of some example embodiments, other relationships and magnitudes of dimensions are included in these examples. As used herein, “azimuthal” and “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature. “Length” and “width” are substantially perpendicular dimensions of a referenced feature, with “length” generally being a longest dimension of the feature.

The inventors have recognized a need for more reliable steam separator tube alignment and securing the whole steam separator assembly with desired internal and relative positioning in an operating reactor environment. Related art tie bars may poorly align individual separator tubes where they touch several separator tubes only at a single contact point. Further, tie bars may become damaged easily by impacts and vibrations, potentially releasing waste into the reactor and losing contact with or alignment of underlying separator tubes. Tie bars touching only a subset of separator tubes further require a substantial and heavy guide ring to unify and handle the steam separator assembly, which in turn must be supported and properly separated from other reactor internals. While these problems illustrate a need for a more rigid and complete alignment in steam separator assemblies, the inventors have further recognized a compounding problem that large amounts of direct contact between separator tubes and securing structures can cause fretting and generate debris from flow induced vibration and shocks in the directly contacting structures. To overcome these newly-recognized problems as well as others, the inventors have developed example embodiments and methods described below to address these and other problems recognized by the inventors with unique solutions enabled by example embodiments.

The present invention is steam separator assemblies, securing structures therein, and methods of fabricating, installing, and/or removing the same. In contrast to the present invention, the few example embodiments and example methods discussed below illustrate just a subset of the variety of different configurations that can be used as and/or in connection with the present invention.

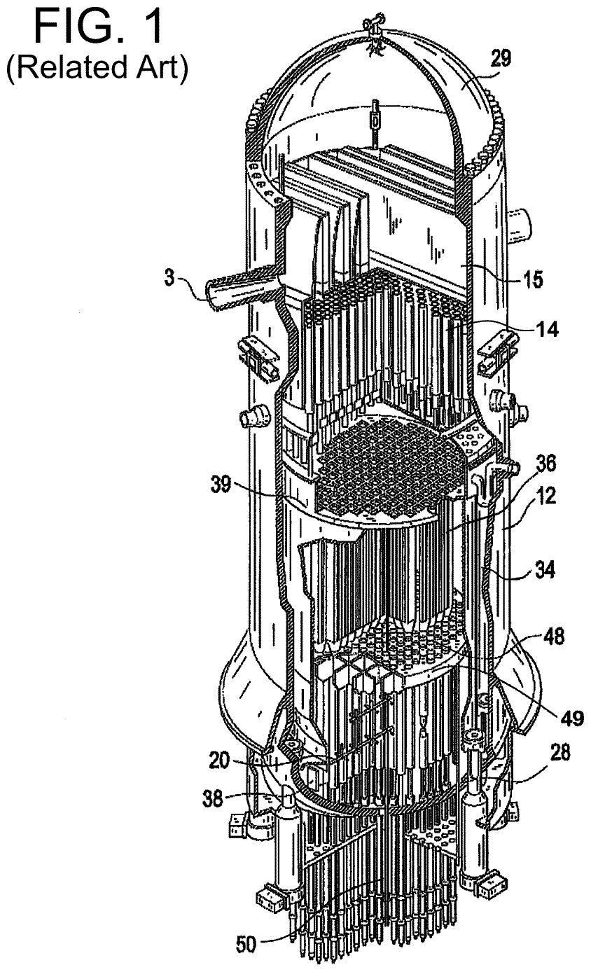

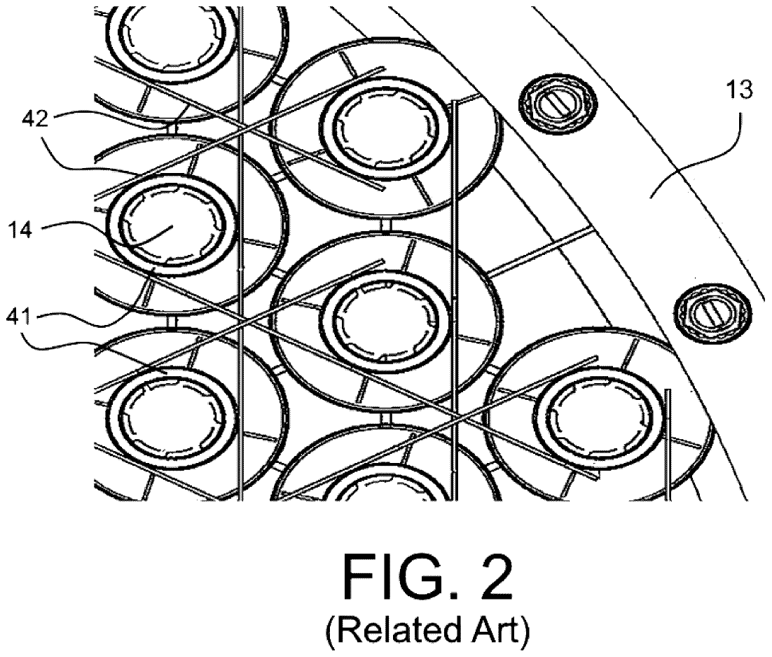

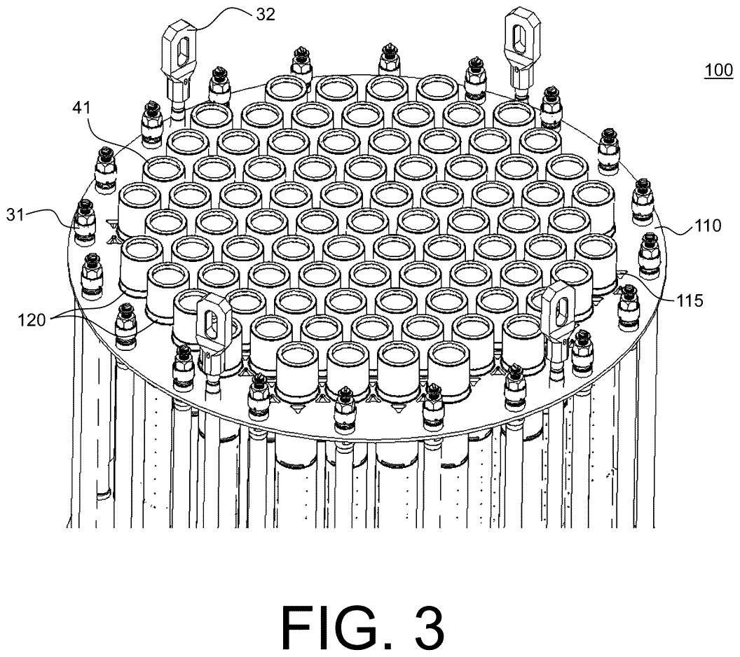

FIG. 3 is an illustration of an example embodiment steam separator assembly 100 using an example embodiment guide plate 110 in a nuclear reactor. Assembly 100 is useable interchangeably with existing related art steam separator assemblies for boiling water reactors, such as to replace related art assembly 14 (FIG. 1), in a shroud or chimney region of a nuclear reactor, above a core and below steam exit from the reactor vessel. Example embodiment assembly may be installed following operation of a related art assembly or for installation in a new plant, for example. In the example of commercial BWR power plants, assembly 100 may be cylindrical and several meters in radius or otherwise sized to fit within an upper reactor pressure vessel chimney space. Similarly, assembly 100 may be used in any type of plant design, including new and unconventional reactors, simply by resizing and shaping the assembly to fit within the same and receive flow from a core.

As shown in FIG. 3, example embodiment steam separator assembly 100 includes guide plate 110 near or at an upper vertical end of steam separator tubes 41 in the assembly. Assembly 100 provides separation and support to each separator tube 41 by allowing their ends to pass through secured plate 110. Any tie bars or guide ring may be omitted in example embodiments; however, they may also be used in addition to the same. Guide plate 110 alone may be sufficient to align and prevent skewing or other movement among separator tubes 41. Although example embodiment steam separator assembly 100 is shown aligning several separator tubes 41, such as all separator tubes within the assembly and/or reactor, assembly 100 may receive and align only a subset of separator tubes 41.

Any existing, conventional, and/or nearby structures may also be accommodated in example embodiment steam separator assembly 100. For example, as shown in FIG. 3, lifting rods 32 extending down to a base of the assembly and connecting to a base plate or other support may pass through plate 110, such that lifting rods 32 can still be accessed to manipulate or position assembly 100 or any other structure. Similarly, shroud head bolts or chimney head bolts 31 may pass through guide plate 110 and secure the same in the same fashion as a guide ring is secured in related designs.

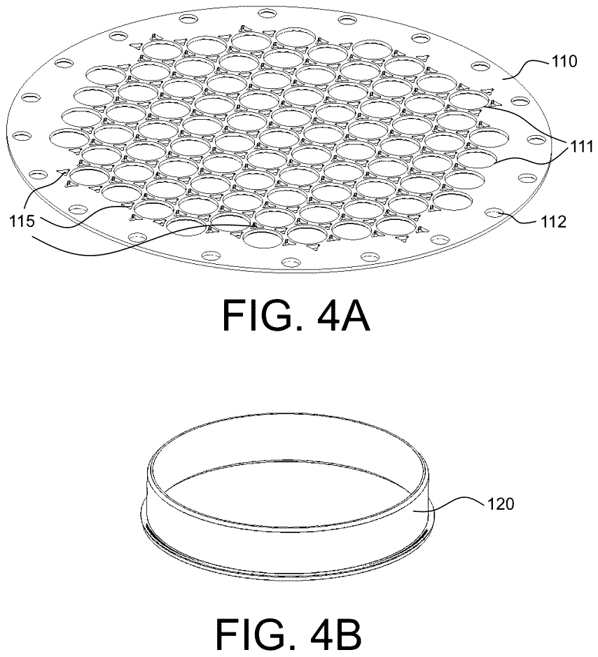

FIGS. 4A and 4B are detailed illustrations of an example embodiment guide plate 110 and guide sleeve 120, respectively, useable in example embodiment assembly 100 (FIG. 3). As shown in FIG. 4A, guide plate 110 includes one or more separator tube holes 111 positioned and sized to receive a corresponding separator tube. Any number of holes 111 may be used, including up to a number of holes 111 for all separator tubes within a steam separator assembly or reactor vessel. Similarly, holes 111 may be at any position or pattern to match separator tube position, including a filled hexagonal array shown in FIG. 4A. Guide plate 110 may include peripheral holes 112 to accommodate lifting rods or chimney head bolts, to allow structures to pass through plate 110 and/or immovably secure plate 110 with a remainder of the separator assembly and/or other reactor structures.

Holes 111 may be slightly larger than an outer perimeter or circumference of the tubes at the axial level of guide plate 110. This may permit installation of guide plate 110 over an end of separator tubes 41 during manufacture and ensuring specific vertical heights and relations among the plate and separator tubes. A tolerance between holes 111 and separator tubes 41 further avoids fretting caused by direct contact between plate 110 and separator tubes 41 that might occur from vibration or shocks. A lack of direct contact between plate 110 and separator tubes may still prevent large degrees of skewing and other movement and also allow indirect contact that may secure the structures together.

Guide plate 110 may further include cross-flow holes 115 that allow fluid to pass through plate 110 and around separator tubes that may fill holes 111. Cross-flow holes 115 may be, for example, triangular cut-outs or other shapes positioned around separator tube holes 111. In the example of FIG. 4A, cross-flow holes 115 are six-fold evenly distributed about each separator tube hole 111. Sizes and numbers of cross-flow holes 115 may be chosen based on desired or expected fluid flow volumes at the axial level of plate 110 in a reactor vessel. For example, cross-flow holes 115 may be chosen with a largest dimension of only a few inches or less to prevent tooling or loose parts from readily passing through plate 110 while permitting ample cross-flow through a number of holes 115.

FIG. 4B is an illustration of guide sleeve 120 that may be secured to the guide plate about a separator tube and associated hole. Guide sleeve may completely or partially extend about an associated hole and extend upward for a distance sufficient for securing to a separator tube. For example, guide sleeve 120 may be a partially annular or toroidal shape with decreasing internal radius with height. In this way, as shown in FIGS. 3 and 4A, if separator tube holes 111 are slightly larger than separator tubes 41, guide sleeve 120 may match both perimeters at different axial heights —separator tube holes 111 at a base of guide sleeve 120 and then separator tube 41 at an opposite upper end of guide sleeve 120.

Guide sleeve 120 may be secured to separator tubes 41 and guide plate 110, forming a rigid single structure that prevents relative movement and limits vibration. For example, each guide sleeve 120 may be welded to one separator tube 41 and guide plate 110 at a separator tube hole after guide plate 110 has been slipped over the separator tubes, permitting adjustment and ensuring exact heights of guide plate 110 and separator tubes in example embodiment assemblies. Similarly, for example, guide sleeves 120 each may be individually welded or otherwise secured with a corresponding separator tube all at a desired distance from a top of the separator tubes and thus the steam separator assembly. If tube holes 111 are slightly larger than the separator tubes, all welded tubes and sleeves may be passed through holes 111 down to sleeve 120 that stops further movement of the tubes and sleeves through guide plate 110. Each sleeve 120 may then be welded to guide plate 110, and all other steam separator assembly components assembled and secured at the elevation. Because all of guide sleeves 120, separator tubes 41, and guide plate 110 may be secured, no gussets or separate fasteners for a guide ring or other support are required.

Guide plate 110 may be substantially rigid and strong, such that plate 110 may be relatively thin while securing the separator tubes in alignment. For example, guide plate 110 may only be an inch to two inches thick in vertical height or less. This thinness and cut outs for various holes across plate 110 may result in guide plate 110 weighing less than a conventional guide ring that is two inches thick. By extending across several separator tubes 41, potentially to an edge of an upper chimney region in a nuclear reactor vessel, guide plate 110 may further allow handling and installation/removal of entire assembly 100, potentially including all separator tubes within the vessel, with a single set of movements.

Example embodiment system 100 may be fabricated of resilient materials that are compatible with a nuclear reactor environment, without substantially changing in physical properties, such as becoming substantially radioactive, melting, embrittlement, and/or retaining/adsorbing radioactive particulates. For example, several known structural materials, including austenitic stainless steels 304 or 316 and martensitic stainless steels 9Cr-1Mo and 2.25Cr-1Mo, XM-19, zirconium alloys, nickel alloys, Alloy 600, non-soluble plastics with high density, strength, and melting point, etc. may be chosen for any element of components of example embodiment assemblies. Direct connections between distinct parts and all other direct contact points may be lubricated, insulated, coated, and/or fabricated of alternating or otherwise compatible materials to prevent seizing, fouling, metal-on-metal reactions, fretting, etc.

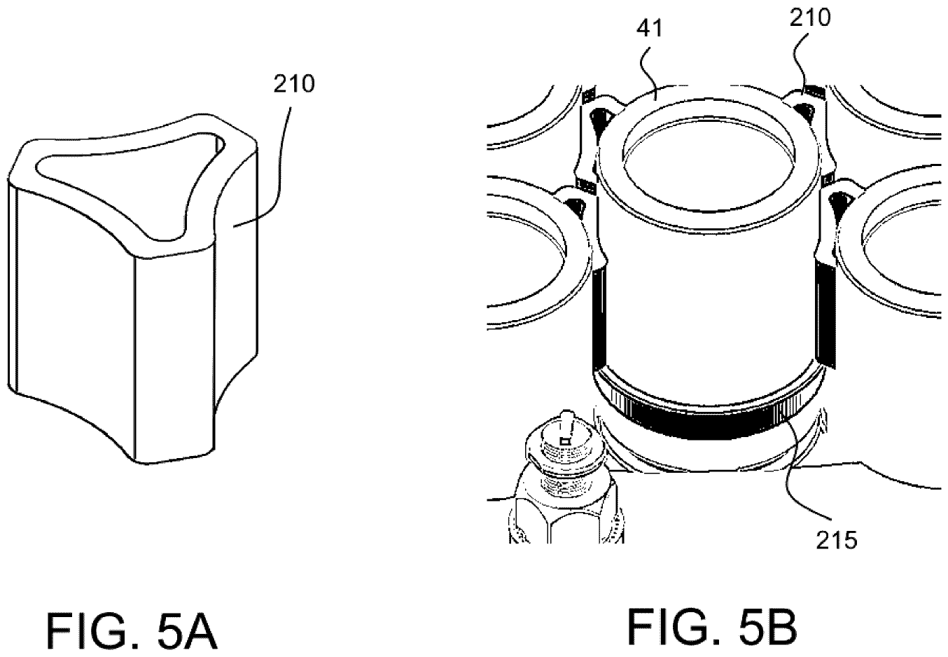

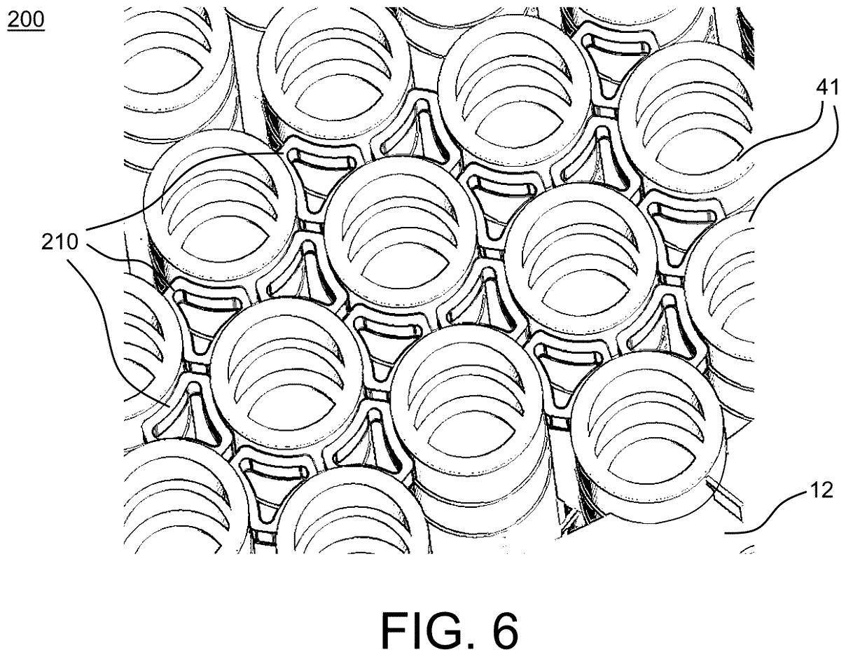

FIGS. 5A-6 are illustrations of another example embodiment steam separator assembly 200. While assembly 200 includes similar features and is useable in the same fashion as other example embodiments, assembly 200 may use gussets 210 with sleeves 215 secured to separator tubes 41 for a guide plate. As shown in FIG. 5A, gussets 210 may have exterior surfaces that match the anticipated perimeters of several adjacent separator tubes, with a largely open central passage. As shown in FIG. 5B, gussets 210 may be sized to match or fit against multiple separator tubes 41, with matching exterior surfaces and tube perimeter. For example, one gusset 210 may fit among and/or contact three directly adjacent separator tubes 41. Gussets 210 may be sized to securely directly contact separator tubes 41, such as through friction, or may be slightly smaller than an opening between separator tubes 41 to allow space or tolerance between gusset 210 and each separator tube 41. Avoiding direct contact between gussets 210 and separator tubes 41 when properly aligned may avoid fretting from flow-induced vibration or shocks, while limiting deflection if alignment fails.

Sleeves 215 are secured to at least one gusset 210 and separator tube 41. As shown in FIG. 5B, multiple gussets 210 may connect to a single sleeve 215, such as through welding or single-piece forging. Similarly, a single gusset 210 may be connected to multiple sleeves about each separator tube 41. Sleeves 215 are securely joined to separator tube 41, such as about a lower vertical perimeter of separator tube 41 that sleeves 215 match. Alternatively, sleeves 215 may join above and/or in a middle of gussets 210 instead of a bottom of the same, depending on desired vertical positioning of gussets 210 and sleeve 215. Sleeves 215 may be welded or otherwise secured to an individual separator tube 41 once a desired positioning is achieved, with each gusset similarly secured to a corresponding sleeve. Although sleeves 215 are shown as annular and may completely surround an outer perimeter of separator tubes 41, partial rings and other shapes are useable for sleeves 215.

As shown in FIG. 6, any number of gussets 210 and sleeves may connect to any number of separator tubes 41. For example, all separator tubes 41 within a steam separator assembly may be joined to sleeves, with gussets 210 surrounding all separator tubes 41. At a central or non-edge position, each separator tube 41 may be surrounded by six gussets, for example, while edge positions may surround separator tubes 41 with fewer. Gussets 210 and/or sleeves at an edge position may join to guide ring 12 about an outside or edge of separator tubes 41. Because all gussets 210 may be joined via sleeves on separator tubes 41, the entire example embodiment assembly 200 may be handled via guide ring 12. Because gussets 210 may be largely hollow with open center portions, cross-flow from above and below gussets 210 may be permitted and customized to desired levels of cross-flow by the shape of opening through gussets 210.

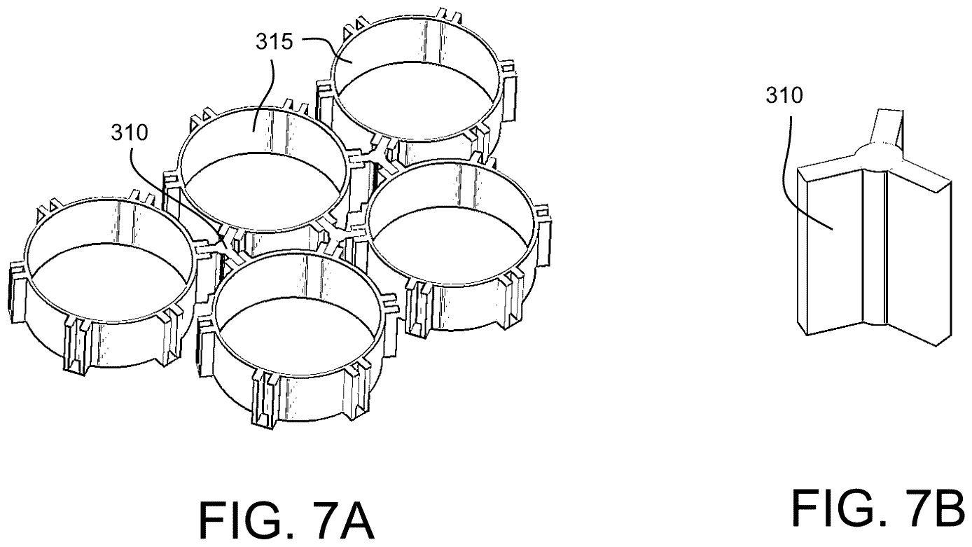

FIGS. 7A and 7B illustrate another example embodiment sleeve 315 and fitting 310 useable for a guide plate in example embodiment steam separator assembly 200. Gussets may be used or omitted from example embodiment sleeve 315. As shown in FIG. 7A, sleeves 315 may be complete or partial cylindrical rings each shaped to match and seat against a separator tube. Sleeves 315 may be secured to the separator tube by welding or other connections that allow sleeves 315 to brace and align the underlying separator tube. Similarly, sleeves 315 may be slightly larger than separator tubes at a desired elevation, permitting some movement or avoiding direct contact except in the instance of alignment correction.

Adjacent sleeves 315 may be joined by brackets that lock with fitting 310 that extends between multiple sleeves 315. For example, fitting 310 may extend into three brackets of adjacent sleeves 315 and be welded in place. Sleeves 315 may have joining brackets for each adjacent sleeve, based on the geometry of nearby separator tubes in the assembly. When rigidly joined by locking fitting 310 in place, sleeves 315 may align and prevent relative movement between all connected separator tubes for all of sleeves 315. Even if slightly larger and/or not directly contacting underlying aligned separator tubes, sleeves 315 may thus be secured and held static for alignment by fittings 310 among all sleeves 315. Fittings 310 may still provide spaces or holes separate from sleeves 315 to allow coolant cross-flow through sleeves 315. Sleeves 315 may otherwise join to a guide ring or other handling structure similar in example embodiment steam separator assembly 200 (FIG. 6).

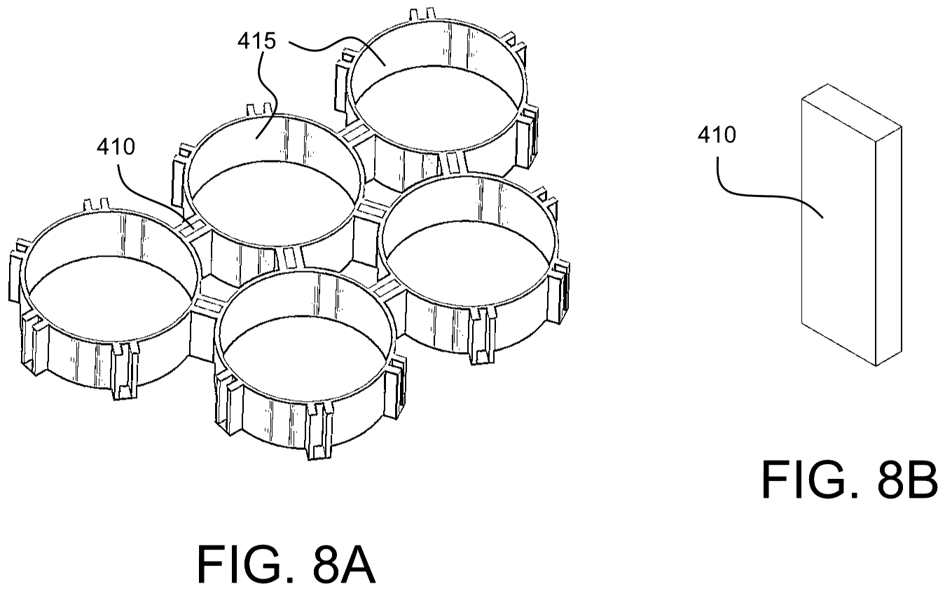

FIGS. 8A and 8B illustrate another example embodiment sleeve 415 useable for a guide plate in example embodiment steam separator assembly 200. Gussets may be used or omitted from example embodiment sleeve 415. As shown in FIG. 8A, sleeves 415 may be complete or partial cylindrical rings each shaped to match and seat against a separator tube. Sleeves 415 may be secured to the separator tube by welding or other connections that allow sleeves 415 to brace and align the underlying separator tube. Similarly, sleeves 415 may be slightly larger than separator tubes at a desired elevation, permitting some movement or avoiding direct contact except in the instance of alignment correction.

Adjacent sleeves 415 may be joined by brackets that lock with fitting 410 that extends between two sleeves 415. For example, fitting 410 may extend into two brackets of adjacent sleeves 415 and be welded in place. Sleeves 415 may have joining brackets for each adjacent sleeve, based on the geometry of nearby separator tubes in the assembly. When rigidly joined by locking fitting 410 in place, sleeves 415 may align and prevent relative movement between all connected separator tubes for all of sleeves 415. Even if slightly larger and/or not directly contacting underlying aligned separator tubes, sleeves 415 may thus be secured and held static for alignment by fittings 410 among all sleeves 415. Fittings 410 may still provide spaces or holes separate from sleeves 415 to allow coolant cross-flow through sleeves 415. Sleeves 415 may otherwise join to a guide ring or other handling structure similar in example embodiment steam separator assembly 200 (FIG. 6).

Example embodiment system 200 may be fabricated of resilient materials that are compatible with a nuclear reactor environment, without substantially changing in physical properties, such as becoming substantially radioactive, melting, embrittlement, and/or retaining/adsorbing radioactive particulates. For example, several known structural materials, including austenitic stainless steels 304 or 316 and martensitic stainless steels 9Cr-1Mo and 2.25Cr-1Mo, XM-19, zirconium alloys, nickel alloys, Alloy 600, non-soluble plastics with high density, strength, and melting point, etc. may be chosen for any element of components of example embodiment assemblies. Direct connections between distinct parts and all other direct contact points may be lubricated, insulated, coated, and/or fabricated of alternating or otherwise compatible materials to prevent seizing, fouling, metal-on-metal reactions, fretting, etc.

In this way example embodiment systems 100 and 200 both provide separator tube alignment structures across a plane of the separator tubes that prevents the separator tubes from becoming unaligned or contacting one another. Because these planar alignment structures in systems 100 and 200 are rigid and secure directly or indirectly to the separator tubes, the entire system may be installed, removed, and/or handled as a single body, such as a single steam separator assembly.

Example embodiments and methods thus being described, it will be appreciated by one skilled in the art that example embodiments may be varied and substituted through routine experimentation while still falling within the scope of the following claims. For example, any number of different separator tubes having alternative shaped and sizes can be braced by a single example embodiment system, and example embodiment systems can be used in several different types of reactor designs, simply through proper dimensioning of example embodiments. Such variations are not to be regarded as departure from the scope of these claims.

What is claimed is:

1. A system for supplementing a separator assembly having a first separator tube and a second separator tube for receiving and separating liquid and vapor coolant flow, the system comprising:
a guide plate defining,
a first separator tube hole shaped to extend around the first separator tube at a first vertical level and not directly contact the guide plate to the first separator tube,
a second separator tube hole shaped to extend around the second separator tube at the first vertical level and not directly contact the guide plate to the second separator tube, and
a plurality of peripheral holes shaped to receive handling structures for securing and handling the system and separator tubes.

2. The system of claim 1, further comprising:
a first sleeve directly secured to the guide plate and extending upward from the first vertical level to directly contact the first separator tube above the guide plate; and
a second sleeve directly secured to the guide plate and extending upward from the first vertical level to directly contact the second separator tube above the guide plate.

3. The system of claim 2, wherein the first sleeve is annular and completely surrounds the first separator tube hole in a transverse direction, and wherein the second sleeve is annular and completely surrounds the second separator tube hole in the transverse direction.

4. The system of claim 1, wherein the guide plate further defines a plurality of cross-flow holes permitting coolant flow across the guide plate.

5. The system of claim 4, where the cross-flow holes are triangular and positioned about the perimeters of the first and the second separator tube holes, and wherein the cross-flow holes have a longest dimension less than 3 inches to prevent tooling from passing across the guide plate.

6. The system of claim 1, wherein the guide plate is rigid with a height of an inch or less in a vertical direction.

7. The system of claim 6, wherein the guide plate is cylindrical with a transverse radius of multiple meters.

8. The system of claim 1, wherein the plurality of peripheral holes are shaped to extend around multiple lifting rods and bolts at the first vertical level.

9. The system of claim 1, further comprising:
the first and the second separator tubes passing through the first and the second separator tube holes in the guide plate at the first vertical level;
at least one lifting rod passing through the peripheral holes in the guide plate at the first vertical level; and
a plurality of chimney head bolts passing through the peripheral holes in the guide plate at the first vertical level, wherein the system forms a steam separator assembly installable in an upper chimney portion above a nuclear core in a reactor vessel.

10. A system for supplementing a separator assembly having a first separator tube and a second separator tube for receiving and separating liquid and vapor coolant flow, the system comprising:
a first sleeve shaped to pass around the first separator tube;
a second sleeve shaped to pass around the second separator tube, wherein the first and the second sleeves are positioned at a substantially same vertical height so as to form a planar alignment structure for the separator tubes; and
a connector securing to the first sleeve and the second sleeve, wherein the connector is configured not to directly contact the first or the second separator tube.

11. The system of claim 10, further comprising:
a third, fourth, and fifth sleeve each shaped to respectively pass around a third, fourth, and fifth separator tube at the substantially same vertical height so as to form the planar alignment structure.

12. The system of claim 11, further comprising:
at least two more of the connectors securing all of the first, second, third, fourth, and fifth sleeves without directly contacting any of the separator tubes.

13. The system of claim 12, wherein the connectors are three-armed fittings fitting into brackets of three of the sleeves or bar fittings fitting into brackets of two of the sleeves.

14. The system of claim 13, wherein the sleeves are all identical rings each having a plurality of the brackets on exterior surfaces to receive the fittings.

15. The system of claim 10, wherein the connector is a gusset having three concave exterior sides shaped to fit between without being directly secured to the separator tubes.

16. The system of claim 10, wherein the connector is a guide plate having a cylindrical shape and a vertical height of an inch or less.

17. The system of claim 10, further comprising:
the first and the second separator tubes passing through the first and the second sleeves at a substantially same vertical level, wherein the system forms a steam separator assembly installable in an upper chimney portion above a nuclear core in a reactor vessel.

18. The system of claim 17, wherein the connector is a guide plate having a cylindrical shape and a vertical height of an inch or less, and wherein the guide plate defines,
a first separator tube hole extending around the first separator tube at a first vertical level and not directly contacting the guide plate to the first separator tube,
a second separator tube hole extending around the second separator tube at the first vertical level and not directly contacting the guide plate to the second separator tube, and
a plurality of peripheral holes shaped to receive handling structures for securing and handling the system and separator tubes.

19. The system of claim 18, further comprising:
a plurality of lifting rods extending vertically through the peripheral holes of the guide plate; and
a plurality of bolts securing through the peripheral holes of the guide plate.

20. A method of forming steam separation structures for a nuclear reactor vessel, the method comprising:
passing a planar alignment structure over ends of a plurality of separator tubes configured to separate liquid and vapor coolant flows, wherein the separator tubes each pass through one separator tube hole of a plurality of separator tube holes in the planar alignment structure, and wherein the planar alignment structure includes a plurality of cross-flow holes entirely separated from the plurality of separator tube holes by solid material; and
securing the planar alignment structure around the plurality of separator tubes at a substantially same axial level to permit movement and handling of the planar alignment structure and separator tubes as a single body.
